(19) United States
(12) Patent Application Publication
(10) Pub. No.: US 2021/0152620 A1
(43) Pub. Date: May 20, 2021

(54) ISOCHRONOUS AUDIO TRANSMISSION

(71) Applicant: QUALCOMM Incorporated, San Diego, CA (US)

(72) Inventors: Lior AMARILIO, Yokneam (IL); Sharon GRAIF, Zichron Yakov (IL); Yiftach BENJAMINI, Givat Ela (IL)

(21) Appl. No.: 16/688,377

(22) Filed: Nov. 19, 2019

(51) Int. Cl. H04L 29/06; H04L 12/40; H04S 1/00

(52) U.S. Cl. CPC H04L 65/607; H04S 1/007; H04L 29/06027; H04L 12/40058

(57) ABSTRACT

In some aspects, the present disclosure provides a method for communicating audio data. In one example, the method includes determining whether a condition for each transport opportunity on an audio channel is met based on an audio sample rate and a channel rate of the audio channel. For each transport opportunity, upon determining that the condition is met for the transport opportunity, the method also includes transmitting audio sample data over the transport opportunity or receiving audio sample data at the transport opportunity.

### TECHNICAL FIELD

The teachings of the present disclosure relate generally to isochronous audio transmission.

### INTRODUCTION

Electronic devices, such as mobile phones and computer tablets, have become common in contemporary society for supporting various everyday uses. These electronic devices are each commonly connected to output audio devices such as speakers, headsets, etc. In certain cases, an audio channel with a certain channel rate may be used at an electronic device (e.g., mobile terminal, host, personal computer, MP3 player, or similar devices) to transport audio sample data to one or more of these output audio devices. The audio channel may be provided over a communications bus. An example of a communications bus is the SoundWire bus.

The MIPI® Alliance has set forth the SoundWire standard, version 1.2 of which was released to adopters on April 2019. Copies of this standard can be found to members of the MIPI® Alliance at https://www.mipi.org/specifications/soundwire. SoundWire is designed as a comprehensive interface and scalable architecture that can be used to enable audio features and functions in multiple types of devices. SoundWire is used as a protocol over the SoundWire bus, which is time division multiplexed (TDM). In certain cases, the audio sample rate may not be the same as the channel rate. In fact, the ratio of the channel rate over the audio sample rate may not even be an integer ratio (i.e., it may be a fractional ratio). When the audio sample rate is not the same as the channel rate, it means that audio sample data may not be available for transmission over every transport opportunity provided by the audio channel. In such cases, it is advantageous for the transmitter of the information (e.g., the source) to determine whether audio sample data is available for transmission over a transport opportunity. It is similarly advantageous for the receiver of the information to be able to determine whether a transport opportunity comprises audio sample data so that it can receive it, if so.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure describes a method for communicating audio data. In one example, the method includes determining whether a condition for each transport opportunity on an audio channel is met based on an audio sample rate and a channel rate of the audio channel. For each transport opportunity, upon determining that the condition is met for the transport opportunity, the method also includes transmitting audio sample data over the transport opportunity or receiving audio sample data at the transport opportunity.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram of an exemplary mobile terminal with audio elements, in accordance with certain aspects of the present disclosure.

FIG. 2 is a block diagram of an exemplary mobile terminal driving an external audio system, in accordance with certain aspects of the present disclosure.

FIG. 3 is a simplified diagram of a SoundWire bus with associated components, in accordance with certain aspects of the present disclosure.

FIG. 4 is a simplified block diagram of ports within SoundWire bus components and a SoundWire bus extending between two components, in accordance with certain aspects of the present disclosure.

FIG. 5A illustrates an example of delivering audio samples with a rate of 44.1 kHz using a channel with a channel rate of 48 kHz, in accordance with certain aspects of the present disclosure.

FIG. 5B illustrates how bits of data associated with two channels, channels 1 and 2, of an audio sample are transported over a transport opportunity, in accordance with certain aspects of the present disclosure.

FIG. 6A illustrates an example of delivering audio samples with a rate of 44.1 kHz using a channel with a channel rate of 48 kHz, using a flow control method, in accordance with certain aspects of the present disclosure.

FIG. 6B illustrates how bits of data associated with two channels, channels 1 and 2, of an audio sample are transported over a transport opportunity, using the flow control method, in accordance with certain aspects of the present disclosure.

FIG. 7 is a flow diagram illustrating example operations for calculating two integer values, M and N, in accordance with certain aspects of the present disclosure.

FIG. 8 is a flow diagram illustrating example operations for receiving audio data performed by a source device, in accordance with certain aspects of the present disclosure.

FIG. 9 is a flow diagram illustrating example operations for transmitting audio data performed by a sink device, in accordance with certain aspects of the present disclosure.

FIG. 10A is a flow diagram illustrating example operations for audio communication performed by a sink or a source device, in accordance with certain aspects of the present disclosure.

FIG. 10B is a flow diagram illustrating example operations performed by a sink or a source device, in accordance with certain aspects of the present disclosure.

FIG. 11 illustrates a graph including a sequence of transport opportunities occurring as time passes, some of which transport audio samples, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

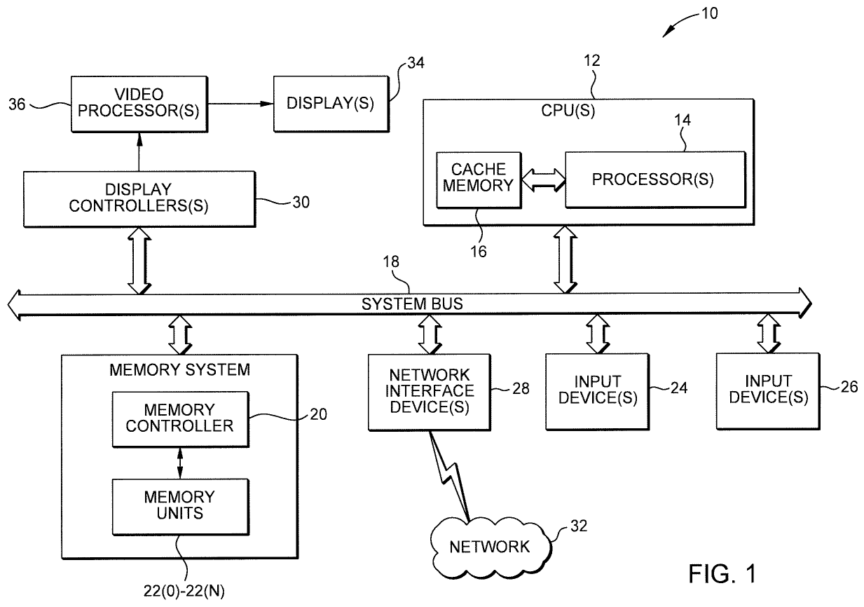

FIG. 1 illustrates an example of a mobile terminal 10. While a mobile terminal 10 is specifically illustrated, other processor-based systems that employ a time division multiplexed bus for multi-channel audio may also benefit from aspects of the present disclosure. In this example, the mobile terminal 10 includes one or more central processing units (CPUs) 12, each including one or more processors 14. The processors 14 may include one or more application processors that handle audio processing. The CPU(s) 12 may have cache memory 16 coupled to the processor(s) 14 for rapid access to temporarily stored data. The CPU(s) 12 is coupled to a system bus 18 and can intercouple devices included in the mobile terminal 10. As is well known, the CPU(s) 12 communicates with these other devices by exchanging address, control, and data information over the system bus 18. For example, the CPU(s) 12 can communicate bus transaction requests to a memory controller 20 to access memory units 22(0)-22(N). Although not illustrated in FIG. 1, multiple system buses 18 could be provided, wherein each system bus 18 constitutes a different fabric. Likewise, in an exemplary aspect, one of the system buses 18 may be a bus for audio, such as a SoundWire bus. In another exemplary aspect, a SoundWire bus may be present for one or more input devices (e.g., a microphone) and for one or more output devices (e.g., a speaker). The SoundWire bus is configured to handle the SoundWire protocol. In one example, the SoundWire bus may be used as a speaker path to transport audio sample data from mobile terminal 10 to an output device such as a codec, speaker, headset. Any generation of the SoundWire protocol, such as the SoundWire Next protocol, is within the scope of this disclosure. Additional information relating to the SoundWire protocol may be found at https://www.kernel.org/doc/html/latest/driver-api/soundwire/index.html, which is hereby incorporated by reference in its entirety.

Other devices can be connected to the system bus 18. As illustrated in FIG. 1, these devices can include a memory system that includes memory controller 20 and memory units 22(0)-22(N), one or more input devices 24, one or more output devices 26, one or more network interface devices 28, and one or more display controllers 30, as examples. The input device(s) 24 can include any type of input device, including but not limited to input keys, switches, microphones, voice processors, etc. The input device 24 may be connected to a SoundWire bus. The output device(s) 26 can include any type of output device, including but not limited to audio (e.g., speakers, headsets, etc.), video, other visual indicators, codec, etc. Codec is a device or computer program for encoding or decoding a digital data stream or signal. The output device 26 may be connected to a SoundWire bus. The network interface device(s) 28 can be any devices configured to allow exchange of data to and from a network 32. The network 32 can be any type of network, including but not limited to a wired or wireless network, a private or public network, a local area network (LAN), a wide area network (WAN), a wireless local area network (WLAN), and the Internet. The network interface device(s) 28 can be configured to support any type of communications protocol desired.

The CPU(s) 12 may also be configured to access the display controller(s) 30 over the system bus 18 to control information sent to one or more displays 34. The display controller(s) 30 sends information to the display(s) 34 to be displayed via one or more video processors 36, which process the information to be displayed into a format suitable for the display(s) 34. The display(s) 34 can include any type of display, including but not limited to a cathode ray tube (CRT), a light emitting diode (LED) display, a liquid crystal display (LCD), a plasma display, etc.

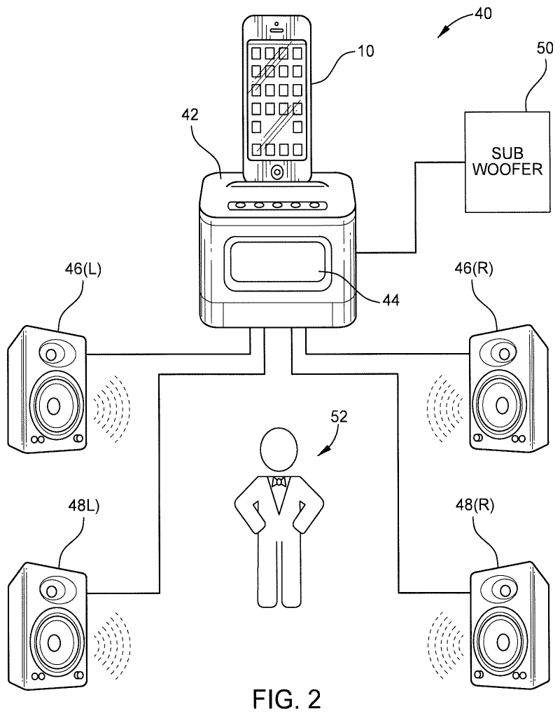

While the mobile terminal 10 may include plural speakers and/or plural microphones coupled by a SoundWire bus, the mobile terminal 10 may be coupled to an external sound system such as through a docking station (or wirelessly). In this regard, FIG. 2 illustrates a 5.1 channel surround sound system 40 with mobile terminal 10 associated with a docking station 42. The docking station 42 may include a center speaker 44 and couple to front speakers 46(L) and 46(R) as well as rear speakers 48(L) and 48(R) and a sub-woofer 50. As is well understood, each speaker 44, 46(L), 46(R), 48(L), and 48(R), and sub-woofer 50 may have a separate audio channel. When the output of the speakers 44, 46(L), 46(R), 48(L), and 48(R) and sub-woofer 50 is properly aligned, a listener 52 may experience high audio fidelity.

Note a mobile terminal 10 is merely described herein as an example of a device with a speaker path to an input device or an output device (e.g., an audio component such as a microphone, speaker, headset, coded, or other audio devices). Other examples of such devices include a personal computer, tablet, MP3 Player, or any other electronic device that can be configured with a speaker path to an audio component. Such devices are also within the scope of this disclosure.

Regardless of whether the audio components are internal to the mobile terminal 10 (or other processor based device) or an external system, the mobile terminal 10 (or other processor based device) may include a SoundWire bus to move audio data between audio components such as modems, codecs, and/or applications processors.

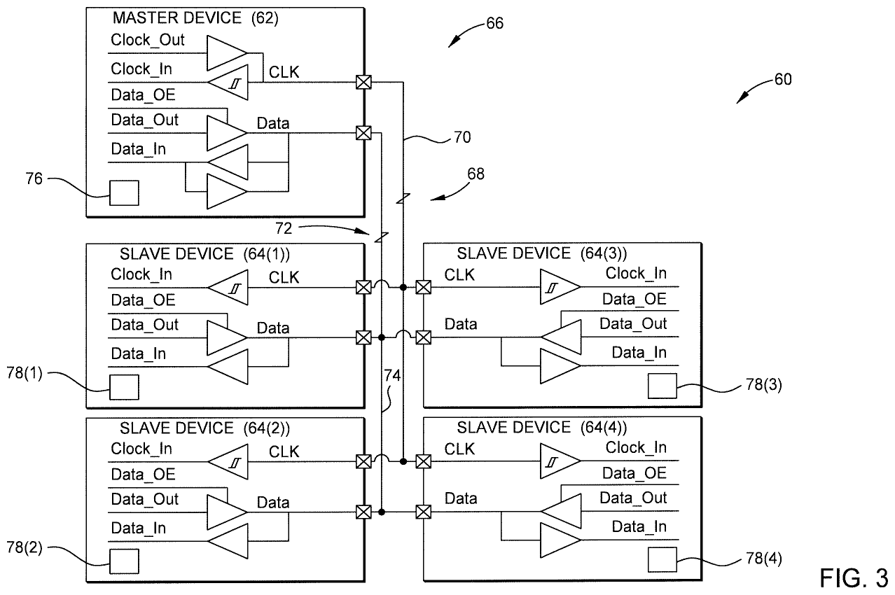

In this regard, a simplified audio system 60 is illustrated in FIG. 3. Simplified audio system 60 may include a master 62 (sometimes referred to as a master device, but because “device” sometimes has additional connotations, referred to simply as “master” hereinafter) and slave devices 64(1)-64(4) communicatively coupled to a communications bus 66 as components. Communications bus 66 may be a SoundWire bus. In an exemplary aspect, the slave devices 64(1)-64(4) may be microphones, speakers, headsets, codec, or other audio devices. The master 62 may be an application processor, a codec, or a modem, and communicates with the slave devices 64(1)-64(4) using two signals: a clock signal 68 communicated over a common clock wire 70, and a data signal 72 communicated on a common data wire 74. While only four slave devices 64(1)-64(4) are illustrated in FIG. 3, it should be appreciated that more or fewer components may be coupled to the communications bus 66. It should be appreciated that the master 62 may have a control system (CS) 76 associated therewith, which may be a hardware implemented processor with associated software stored in memory associated with the processor. In an exemplary aspect, the control system 76 is part of the system on a chip (SoC) of the master 62. In an alternate exemplary aspect, the control system 76 may be associated with the CPU 12 of the mobile terminal 10. In further exemplary aspects, the slave devices 64(1)-64(4) each have a respective slave control system 78(1)-78(4).

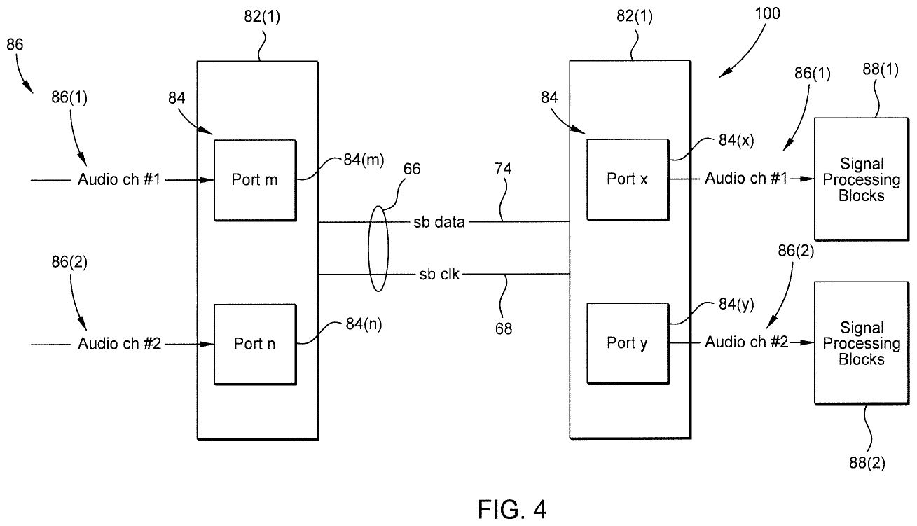

It should be appreciated that each component within the simplified audio system 60 may include multiple ports, each of which may be assigned to different audio channels. Exemplary aspects of this arrangement are illustrated in FIG. 4. In particular, an audio system 80 may include a first component 82(1) and a second component 82(2). First component 82(1) may include plural ports 84, of which 84(m) and 84(n) are illustrated. Similarly, second component 82(2) may include plural ports 84, of which 84(x) and 84(y) are illustrated. Ports 84 receive audio channels 86. In particular, port 84(m) receives first audio channel 86(1) and port 84(n) receives second audio channel 86(2). A serializer (not illustrated) assembles the audio data and places the audio data on the data wire 74. The second component 82(2) uses a deserializer (not illustrated) to extract the data and pass the data to an appropriate port 84. In this example, the data for first audio channel 86(1) is passed to port 84(x) and the data for second audio channel 86(2) is passed to port 84(y). The ports 84 pass the separated audio channels 86(1) and 86(2) to appropriate signal processing blocks 88(1) and 88(2).

In certain cases, it may be desired to deliver a native audio stream, which is an audio stream that is delivered as it was sampled, over a channel with a different audio clock rate or channel rate. In such cases, the ratio between the pulse density modulation (PDM) sample rate of the native audio stream and the channel rate may be a fractional ratio, instead of an integer ratio. A common example of this is delivering a 44.1 kilohertz (kHz) audio stream over a 48 kHz channel.

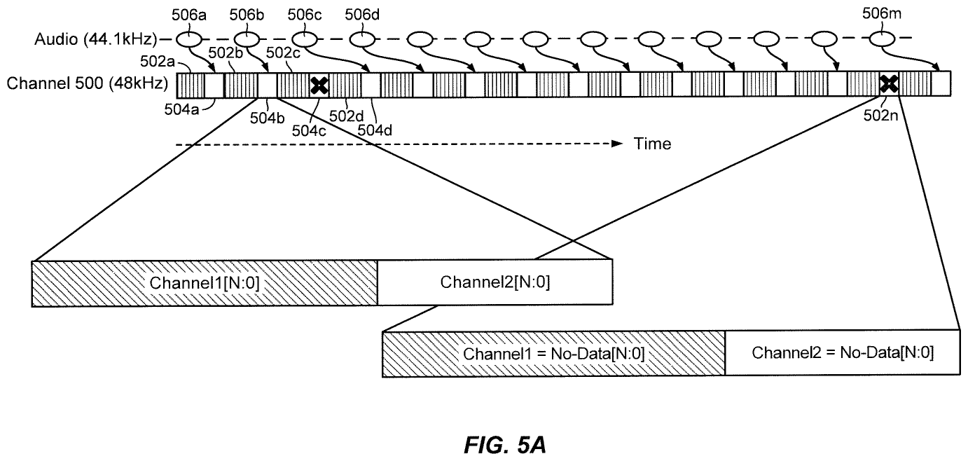

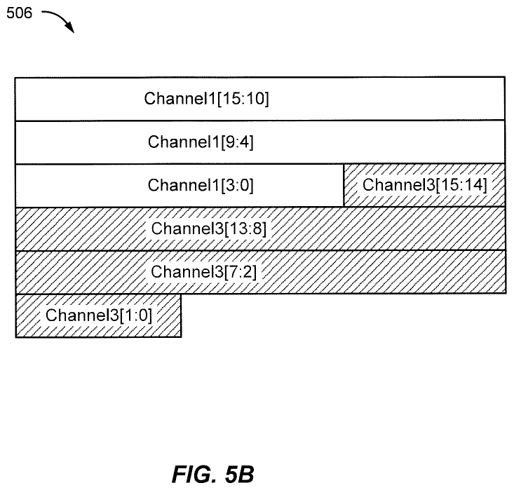

FIG. 5A illustrates an example of delivering audio samples 506 (e.g., 506a, 506b, 506c, etc.) with a rate of 44.1 kHz using a channel 500 with a channel rate of 48 kHz. Channel 500 is time division multiplexed (TDM'ed), such that at certain time intervals, channel 500 provides an audio sample transport opportunity. A transport opportunity refers to a time period during which channel 500 is available to be used for the transmission of audio sample data. For example, as shown, channel 500 provides audio sample transport opportunities 504a, 504b, 504c, etc. (collectively referred to as transport opportunities 504). Channel 500 is shared and, therefore, also used for transmission of other information or signals during time periods 502a, 502b, etc. (collectively referred to as time periods 502). As shown, because the audio sample rate of 44.1 kHz is lower than the 48 kHz channel rate of channel 500, one or more transport opportunities 504 may not be used for transporting audio samples 506. For example, audio sample 506c may not be available in time to be transported in transport opportunity 504c. This is because audio samples 506 and channel 500 are provided and transmitted, respectively, in real time. As such, transport opportunity 504c is not used for transporting audio sample 506c. Instead, audio sample 506c is transported in transport opportunity 504d.

FIG. 5B illustrates how bits of data associated with two channels, channels 1 and 2, of an audio sample 506 are transported over a transport opportunity 504. As shown, the transmission starts with the source (e.g., master 62) transmitting bit 15 of channel 1, then bit 14 of channel 1, and so on, and subsequently bit 0 of channel 1, to a sink (e.g., one or more of slaves 64). The source, herein, refers to a transmitter of information while the sink refers to a received of the information. Then the source starts transmitting bit 15 of channel 2 and so on, until bit 0 of channel 2 is also transmitted. FIG. 5B illustrates an example of an isochronous transport such that an audio sample, such as audio sample 506, is transported in a transport opportunity at “sample intervals” (e.g., every 2 micro seconds) of an integer number of clocks.

In the example of FIGS. 5A-5B, however, the sink or the receiver of channel 500 is not able to determine whether a certain transport opportunity includes an audio sample or not. For example, the sink is not able to determine whether transport opportunity 504c includes any audio sample data or not. As such, in certain cases, a method referred to as the flow control method is implemented by which the source (i.e., the transmitter) uses two bits to indicate whether a transport opportunity comprises an audio sample or not. For example, the source starts the transmission of each audio sample with two bits, including a receive ready (RxRdy) bit and a transmit ready (TxRdy) bit. If both of the two bits are set (e.g., RxRdy=1 and TxRdy=1), then it means that the corresponding transport opportunity comprises audio sample data. However, if the two bits are not set, then the receiver is able to determine that the transport opportunity does not comprise audio sample data. Note that a transport opportunity comprising an audio sample herein refers to the audio sample being transmitted over or during the transport opportunity.

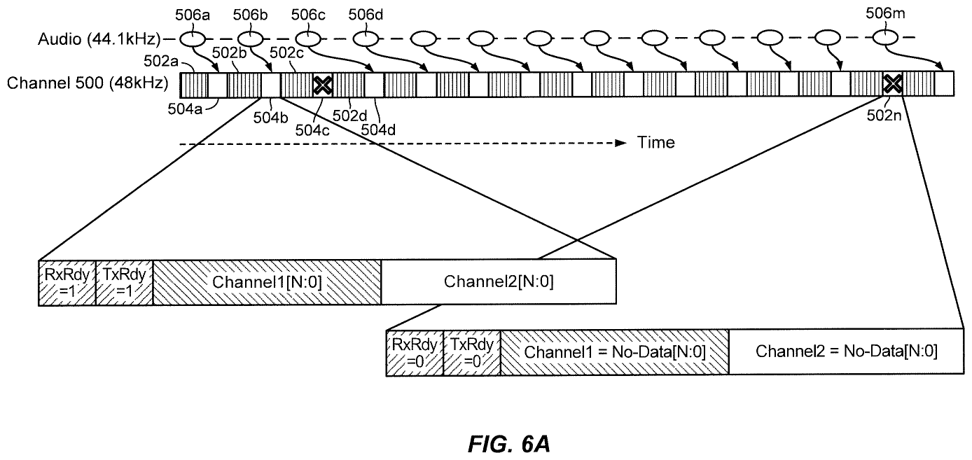

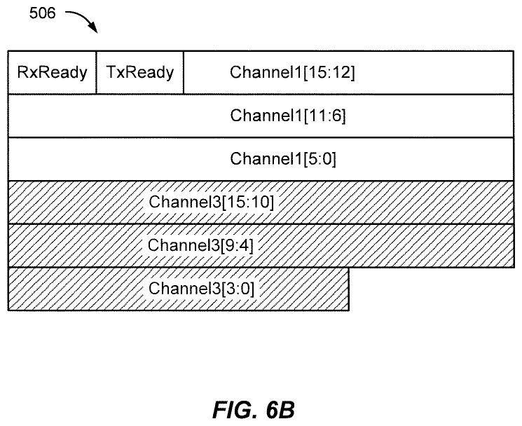

FIG. 6A illustrates an example of delivering audio samples 506 (e.g., 506a, 506b, 506c, etc.) with a rate of 44.1 kHz using a channel 500 with a channel rate of 48 kHz, using the flow control method. As shown, prior to transmitting audio sample 506b in transport opportunity 504b, the source uses the RxRdy and TxRdy bits, which are both set, to indicate that transport opportunity 504b includes an audio sample, in this case audio sample 506b. In the case of transport opportunity 504n, because the source is not transmitting any audio sample in that transport opportunity, the RxRdy and TxRdy bits are not set, which provides an indication to the receiver that an audio sample is not transmitted over transport opportunity 504n.

FIG. 6B illustrates how bits of data associated with two channels, channels 1 and 2, of an audio sample 506 are transported over a transport opportunity 504. As shown, using the flow control method, the source transmits two bits, which the source has set, before transmitting audio sample 506 in order to indicate to the sink that an audio sample is transmitted over transport opportunity 504.

Utilizing the flow control method when transporting single bit direct stream digital (DSD) audio samples over a channel with a common channel rate, however, causes a very large overhead and requires a larger bandwidth. DSD uses a single bit of information, which indicates whether the current sample of the analogue waveform is higher or lower than in the previous one. A single DSD corresponds to 1 bit with a 2.8224 MHz sampling rate. A double DSD corresponds to 1 bit with a 5.6448 MHz sampling rate. A quadruple DSD corresponds to 1 bit with a 11.2896 MHz sampling rate.

As discussed, transmitting two bits (e.g., RxRdy and TxRdy) with a single bit of audio data (i.e., 1-bit DSD) results in about 200% overhead. Although transmitting a single DSD with this large overhead may be possible using a common link capacity, transmitting a double DSD or a quadruple DSD with this overhead may require a bandwidth that exceeds the common link capacity.

Accordingly certain embodiments described herein relate to configuring the source (e.g., master 62) to independently determine whether there is audio sample data (e.g., DSD audio sample) available to be transmitted over a certain transport opportunity while also configuring the sink (e.g., slave 64) to independently determine whether a certain receiving opportunity is transporting an audio sample. The source and the sink being configured to independently make these determinations allows for transmitting audio samples with any rate over a channel with a common bandwidth (e.g., bandwidth used for isochronous transport, as described in relation to FIG. 2) and a commonly used channel rate without having to use the flow control method described above. The embodiments described herein are advantageous especially when the ratio between the audio sample rate and the channel rate is a fractional ratio, instead of an integer ratio. Also the embodiments described herein are advantageous especially in use-cases where the audio sample rate is high, such as with a single, double, and quadruple DSD.

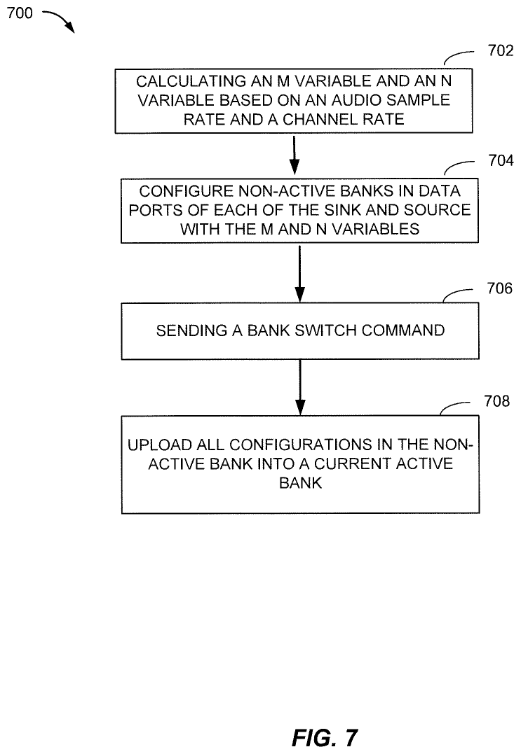

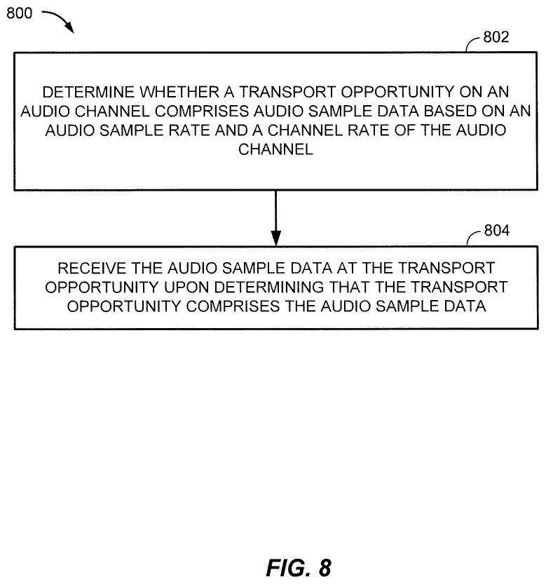

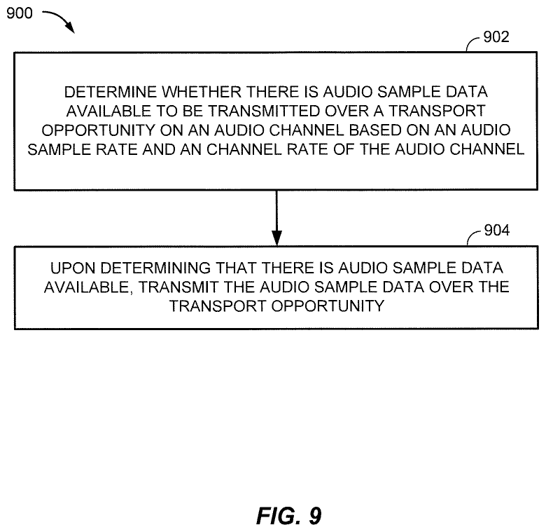

In order to make the determinations described above, the source and the sink are configured, as further described below, to independently perform a set of one or more calculations to generate two integer values, referred to as M and N, based on an audio sample rate and a channel rate. M represents an integer corresponding to the audio sample rate associated with the audio data that is being transmitted over an audio channel (e.g. SoundWire bus) between the source and the sink. N represents an integer corresponding to the channel rate of the audio channel between the sink and the source. As described in more detail in relation to FIG. 7, registers in the data ports associated with the sink and the source are then configured with the M and N. The data ports of the sink and the source are each also configured with an algorithm to use M and N as inputs, allowing the source to perform operations 800 of FIG. 8 and the sink to perform operation 900 of FIG. 9.

FIG. 7 illustrates a flow diagram illustrating operations 700 for calculating M and N, described above. Operations 700 may be performed by both the source and the sink. Operations 700 may begin, at 702, by calculating M and N based on an audio sample rate and a channel rate. For example, both the source and the sink may be configured with information indicating an audio sample or DSD rate of, e.g., 2.8224 MHz and a channel rate of, e.g., 3.072. Using the audio sample rate and channel rate, each of the sink and the source is configured to utilize a formula to generate M and N. The formula for calculating M is:

M=LCM(audio sample rate, channel rate)/sample rate

In the formula above, LCM stands for the least common multiplier. As such, M is equal to the least common multiplier of the audio sample rate and the channel rate, divided by the audio sample rate. The formula for calculating N is:

N=LCM(audio sample rate, channel rate)/channel rate

As such, N is equal to the least common multiplier of the audio sample rate and the channel rate, divided by the channel rate. In the example where the DSD rate is 2.8224 MHz and the channel rate is 3.072, then M is 147 and N is 160. This means that for an embodiment where the DSD rate is 2.8224 MHz and the channel rate is 3.072, for every 160 transport opportunities in an audio channel, only 147 actual audio samples are delivered.

At 704, operation 700 continue by configuring the non-active banks in data ports of each of the sink and the source with information, including M and N. As one of ordinary skill in the art can appreciate, each data port in a sink or a source may comprise at least two sets of configuration registers. One set of registers represents a current active bank (e.g., current active configuration bank), which is used by the data port when the data port is active or operating. The other set of registers represent a “next” or a “non-active” bank, which allows the data port to be configured while it is operating. Any configuration in the non-active bank, however, is not uploaded to the current active bank until a bank switch event. Any configuration that is not uploaded to the active current bank is not used by the data port. A bank switch event refers to an operation by which the configurations in the non-active bank are uploaded to the current active bank. A bank switch event, as one of ordinary skill in the art can appreciate, occurs at a synchronous stream point (SSP). A SSP refers to a periodic point in time, at which all devices (e.g., sink and source) on the link or channel are synchronized. As such, at an SSP, each device is able to determine that it is synchronized with all other devices on the link. Subsequent to a bank switch event, the data port uses the configurations in the most updated current active bank (including the configurations that were previously in the non-active bank and then uploaded to the current active bank at the bank switch event).

At 706, operations 700 continue by sending a bank switch command. Sending a bank switch command refers to writing the command to a register, referred to as SCP_FrameCtrl. If the command is successful, operations 700 move to 708.

At 708, operations 700 continue by uploading all the configurations in the non-active bank into the current active bank. For example, upon the command being successful, the configurations of the non-active bank are selected and uploaded into the current active banks. The link transport is also changed, accordingly.

FIG. 8 is a flow diagram illustrating example operations 800 for receiving audio data, in accordance with certain aspects of the present disclosure. Operations 800 may be performed, for example, by a source, such as master 82. Operations 800 may begin, at 802, by the source determining whether there is audio sample data available to be transmitted over a transport opportunity on an audio channel based on an audio sample rate and a channel rate of the audio channel. At 804, operations 800 continue by receiving the audio sample data at the transport opportunity upon determining that the transport opportunity comprises the audio sample data.

FIG. 9 is a flow diagram illustrating example operations 900 for transmitting audio data, in accordance with certain aspects of the present disclosure. Operations 900 may be performed, for example, by a sink, such as a slave 64. Operations 900 may begin, at 902, by the sink determining whether a transport opportunity on an audio channel comprises audio sample data based on an audio sample rate and a channel rate of the audio channel. At 904, operations 900 continues transmitting the audio sample data over the transport opportunity upon determining that there is audio sample data available.

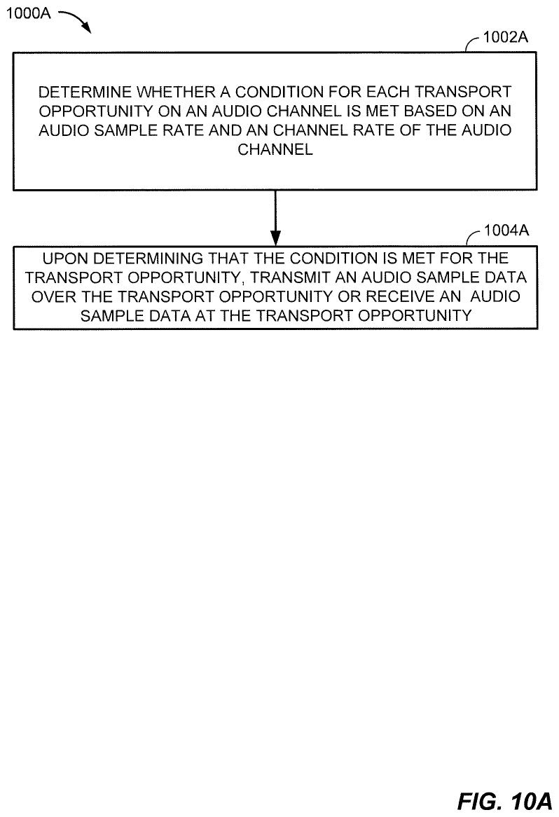

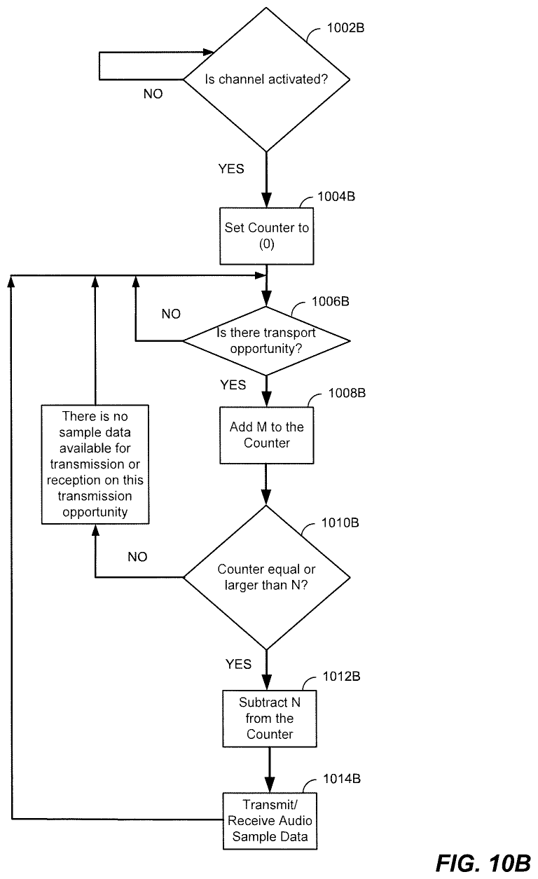

FIG. 10A is a flow diagram illustrating example operations 1000A for communicating audio data, in accordance with certain aspects of the present disclosure. Operations 1000A may be performed by a device, such as a sink or a source. Operations 1000A may begin, at 1002A, by determining whether a condition for each transport opportunity on an audio channel is met based on an audio sample rate and a channel rate of the audio channel. In certain aspects, the condition is whether a counter is equal to or larger than N as described with respect to 1010B of FIG. 10B. At 1004A, operations 1000A continues by either transmitting an audio sample data over the transport opportunity or receiving an audio sample data at the transport opportunity, upon determining that the condition is met.

In certain embodiments, operations 1000A further comprise determining a first integer value and a second integer value based on the audio sample rate and the channel rate. In such embodiments, operations 1000A further comprise initializing a counter to zero.

In certain such embodiments, operations 1000A further comprise configuring a data port of the device with the first integer value, the second integer value, and a counter. In certain such embodiments operations 1000A further comprise initializing the counter to zero at a bank switch event.

In certain embodiments, determining whether the condition is met for each transport opportunity on the audio channel, as described in step 1002A, comprises adding the first integer value to the counter, and subsequent to the adding, based upon determining that a value of the counter is equal to or larger than the second integer value, determining that the condition is met. Having determined that the condition is met, the second integer value is subtracted from the value of the counter. However, based upon determining that the value of the counter does not exceed the second integer value, it is determined that the condition is not met.

In certain embodiments, determining the first integer value and the second integer value based on the audio sample rate and the channel rate is based on the following formulas:

the first integer value=LCM(the audio sample rate, the channel rate)/the audio sample rate

the second integer value=LCM(the audio sample rate, the channel rate)/the channel rate

In certain embodiments, determining whether the condition is met for each transport opportunity comprises determining whether each transport opportunity comprises audio sample data. In such embodiments, the receiving is performed upon determining that the transport opportunity comprises audio sample data.

In certain embodiments, determining whether the condition is met for each transport opportunity comprises determining whether audio sample data is available to be transmitted over the transport opportunity. In such embodiments, the transmitting is performed upon determining that audio sample data is available to be transmitted over the transport opportunity.

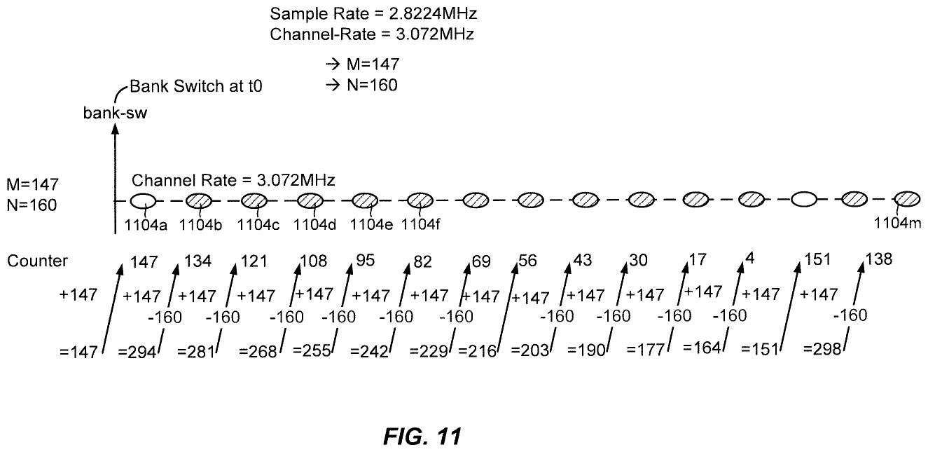

FIG. 10B is a flow diagram that illustrates, in more detail, how operations 1000A of FIG. 10A are performed. More specifically, operations 1000B illustrate in more detail how operations 800 of FIG. 8 and operations 900 of FIG. 9 are performed by the source and the sink, respectively. FIG. 10B illustrates operations 1000B, corresponding to an algorithm or sequence that may be performed by either the sink or the source (e.g., a data port within the sink or the source). Operations 1000B are described in relation to a graph 1100 in FIG. 11, which shows a sequence of transport opportunities 1104 occurring as time passes, some of which transport audio samples. FIG. 11 also illustrates calculations performed based on an example provided above, in which the audio sample rate is 2.8224 MHz, the channel rate is 3.072 MHz, and therefore, M equals 147, and N equals 160.

At step 1002B, a device (e.g., source or sink) determines whether an audio channel is activated. In one example, the audio channel may be activated at a bank switch event. If the channel is activated, the device moves to step 1004B to set a counter to 0. A visual example of a bank switch is shown at t₀. If the audio channel is not activated, the operations 1000 remain in step 1002B until the channel is activated.

At step 1006B, the device determines whether a transport opportunity is present. If not, the device goes back to performing step 1006B until a transport opportunity is present. If yes, the device moves to step 1008B. Transport opportunities occur periodically based on the channel rate. For example, a channel with a channel rate of 3.072 MHz presents 3.072 million transport opportunities per second. In such an example, the device keeps polling until a transport opportunity occurs. In the example of FIG. 11, the device determines that transport opportunity 1104a is present and moves to step 1008B.

At step 1008B, the device adds M to the counter. In the example of FIG. 8, the device adds M, which is 147, to the value of the counter, which is 0.

At step 1010B, the device determines whether the value of the counter is equal to or larger than N. In the example of FIG. 11, the device determines whether the value of the counter is equal to or larger than 160. At this point, the value of the counter is 147, which is smaller than 160. In this example, if the device is a source, then the device determines that there is no audio sample available to be transmitted over transport opportunity 1104a and loops back to step 1006B based on the counter value being less than N. If the device is a sink, then the device determines that there is no audio sample transmitted over transport opportunity 1104a and loops back to step 1006B based on the counter value being less than N.

At step 1006B again, the device determines whether a transport opportunity is present. Continuing with the example above, at some point, the device determines that transport opportunity 1104b is present and, therefore, moves to step 1008B. At step 1008B, the device adds M to the counter. In this example, the device adds 147 to the value of the counter, which is 147, resulting in 294. At step 1010B, the device determines whether the value of the counter is equal to or larger than N. In this example, the device determines that the value of the counter, 294, is larger than N, 160. Based on the value of the counter being greater than or equal to N, the device determines that there is an audio sample available to be transmitted or received over transport opportunity 1104b.

As such, at step 1012B the device subtracts N from the counter. In the above example, the device subtracts 160 from 294, which results in a counter with a value of 134.

At step 1014B, the device transmits the available audio sample over transport opportunity 1104b if the device is a source. If the device is a sink, at step 1014B, the device receives the audio sample transported over transport opportunity 1104b. Having performed step 1014B, the device loops back to step 1006B to determine whether a transport opportunity is present again.

Accordingly, using the embodiments described herein allows for delivering and receiving audio sample data with any audio ample rate over an audio channel with any channel rate.

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method of communicating audio data, comprising:
determining whether a condition for each transport opportunity on an audio channel is met based on an audio sample rate and a channel rate of the audio channel; and
for each transport opportunity, upon determining that the condition is met for the transport opportunity:
transmitting audio sample data over the transport opportunity; or
receiving audio sample data at the transport opportunity.

2. The method of claim 1, comprising:
determining a first integer value and a second integer value based on the audio sample rate and the channel rate; and
initializing a counter to zero, wherein:
for each transport opportunity on the audio channel, determining whether the condition is met comprises:
adding the first integer value to the counter;
subsequent to the adding, based upon determining that a value of the counter is equal to or larger than the second integer value:
determining that the condition is met;
subtracting the second integer value from the value of the counter; and
based upon determining that the value of the counter does not exceed the second integer value:
determining that the condition is not met.

3. The method of claim 2, further comprising:
configuring a data port with the first integer value, the second integer value, and the counter, prior to the initializing.

4. The method of claim 2, wherein initializing the counter to zero is performed at a bank switch event.

5. The method of claim 2, wherein:
determining the first integer value and the second integer value based on the audio sample rate and the channel rate is based on the following formulas:
the first integer value=LCM (the audio sample rate, the channel rate)/the audio sample rate; and
the second integer value=LCM (the audio sample rate, the channel rate)/the channel rate; and
LCM stands for least common multiplier.

6. The method of claim 1, wherein:
determining whether the condition is met for each transport opportunity comprises determining whether each transport opportunity comprises audio sample data; and
the receiving is performed upon determining that the transport opportunity comprises audio sample data.

7. The method of claim 1, wherein:
determining whether the condition is met for each transport opportunity comprises determining whether audio sample data is available to be transmitted over the transport opportunity; and
the transmitting is performed upon determining that audio sample data is available to be transmitted over the transport opportunity.

8. The method of claim 1, wherein a ratio of the audio sample rate over the channel rate is fractional.

9. The method of claim 1, wherein the audio sample data is direct stream digital (DSD) audio sample data.

10. The method of claim 1, wherein the DSD audio sample data is one of single bit with a 2.8224 MHz sampling rate, double bit with a 5.6448 MHz sampling rate, or quadruple bit with a 11.2896 MHz sampling rate.

11. An apparatus, comprising:
a memory comprising executable instructions; and
a processor in data communication with the memory and configured to execute the instructions to cause the apparatus to perform a method, the method comprising:
determining whether a condition for each transport opportunity on an audio channel is met based on an audio sample rate and a channel rate of the audio channel; and
for each transport opportunity, upon determining that the condition is met for the transport opportunity:
transmitting audio sample data over the transport opportunity; or
receiving audio sample data at the transport opportunity.

12. The apparatus of claim 11, wherein the method further comprises:
determining a first integer value and a second integer value based on the audio sample rate and the channel rate; and
initializing a counter to zero, wherein:
for each transport opportunity on the audio channel, determining whether the condition is met comprises:
adding the first integer value to the counter;
subsequent to the adding, based upon determining that a value of the counter is equal to or larger than the second integer value:
determining that the condition is met;
subtracting the second integer value from the value of the counter; and
based upon determining that the value of the counter does not exceed the second integer value:
determining that the condition is not met.

13. The apparatus of claim 12, wherein the method further comprises:
configuring a data port of the apparatus with the first integer value, the second integer value, and the counter, prior to the initializing.

14. The apparatus of claim 12, wherein initializing the counter to zero is performed at a bank switch event.

15. The apparatus of claim 12, wherein:
determining the first integer value and the second integer value based on the audio sample rate and the channel rate is based on the following formulas:
the first integer value=LCM (the audio sample rate, the channel rate)/the audio sample rate; and
the second integer value=LCM (the audio sample rate, the channel rate)/the channel rate; and
LCM stands for least common multiplier.

16. The apparatus of claim 11, wherein:
determining whether the condition is met for each transport opportunity comprises determining whether each transport opportunity comprises audio sample data; and
the receiving is performed upon determining that the transport opportunity comprises audio sample data.

17. The apparatus of claim 11, wherein:
determining whether the condition is met for each transport opportunity comprises determining whether audio sample data is available to be transmitted over the transport opportunity; and
the transmitting is performed upon determining that audio sample data is available to be transmitted over the transport opportunity.

18. The apparatus of claim 11, wherein a ratio of the audio sample rate over the channel rate is fractional.

19. An apparatus, comprising:
means for determining whether a condition for each transport opportunity on an audio channel is met based on an audio sample rate and a channel rate of the audio channel; and
for each transport opportunity, upon determining that the condition is met for the transport opportunity:
means for transmitting audio sample data over the transport opportunity; or
means for receiving audio sample data at the transport opportunity.

20. The apparatus of claim 19, wherein the apparatus further comprises:
means for determining a first integer value and a second integer value based on the audio sample rate and the channel rate; and
means for initializing a counter to zero, wherein:
for each transport opportunity on the audio channel, the means for determining whether the condition is met comprises:
means for adding the first integer value to the counter;
subsequent to the adding, based upon determining that a value of the counter is equal to or larger than the second integer value:
means for determining that the condition is met;
means for subtracting the second integer value from the value of the counter; and
based upon determining that the value of the counter does not exceed the second integer value:
means for determining that the condition is not met.
